(19) United States
(12) Patent Application Publication
(10) Pub. No.: US 2015/0233501 A1
(43) Pub. Date: Aug. 20, 2015

(54) TOROIDAL SEAL AND METHOD FOR THE SEALING OF PIPES

(71) Applicant: BALLTEC LIMITED, Lancashire (GB)

(72) Inventor: Owen Walmsley, Inverness-shire (GB)

(73) Assignee: Balltec Limited, Lancashire (GB)

(21) Appl. No.: 14/433,114

(22) PCT Filed: Sep. 18, 2013
(86) PCT No.: PCT/GB2013/052431

§ 371 Date: Apr. 2, 2015

(30) Foreign Application Priority Data
Oct. 4, 2012 (GB) 1217754.9
Mar. 14, 2013 (GB) 1304569.5

(51) Int. Cl. F16L 19/02; F16J 15/06

(52) U.S. Cl. CPC F16L 19/0218; F16J 15/062

(57) ABSTRACT

The present disclosure relates to methods and apparatus for the sealing of pipes. The apparatus includes a seal, the seal being a toroidal seal. The seal may be formed from a pipe to be sealed by cutting a portion of the pipe to form such a seal. The seal may be machined with generally convex edges. The disclosure also relates to a method of sealing a pipe using such a seal and a method of manufacturing a seal from a pipe to be sealed.

### FIELD OF THE INVENTION

The present invention relates to seals used in pipe gripping apparatus.

### BACKGROUND TO THE INVENTION

Elongate pieces such as pipes, bars and beams have to be manipulated and manoeuvred into place in a structure, such as a pipeline or a frame.

Such pieces may have considerable mass and dimensions, and therefore be cumbersome to properly and safely grip and transport to such a structure.

Prior art solutions have included simply using wire, rope, chain or other tether to surround the circumference of the piece to enable it to be lifted. This is not greatly secure. Increased security may be gained by machining an indentation around the circumference of the piece to provide a seat for the tether. However, this is disadvantageous in that the machining process requires time by a skilled operator, and also permanently alters the outer circumference of the piece providing it with a weakness both from the reduction in circumference and an area of potential stress concentration.

Specific gripping tools have been proposed. One such tool is disclosed in WO 0229301. It covers a fluid pressure actuated gripping device, and includes multiple parts, resulting in a complex device with associated manufacturing impediments.

Seals will be required if the pipe gripping apparatus is used to seal the end of a pipe as can often be the case. Prior art solutions typically depend on elastomeric seals. Although being of a low cost and fulfilling the sealing function, they have disadvantages in that they may easily perish in hostile environments such as exposure to heat or caustic substances.

### SUMMARY OF THE INVENTION

According to a first aspect of the present invention there is provided a seal, the seal comprising a seal body in the form of a toroid, having an outermost edge, an innermost edge and two intermediate edges, wherein the innermost edge and outermost edge are generally linear and parallel to one another, and wherein the two intermediate edges connect the innermost edge and outermost edge, at least one of said intermediate edges being generally convex.

By convex it should be taken that there is a general non-linearity about the shape of the intermediate edge, but may not conform to exact mathematical definition of “convex”. For example, the intermediate edge may be generally triangular with a filleted apex.

The seal may be used to seal a pipe. The seal may have a substantially similar cross-section to that of the pipe. The seal may be formed from substantially the same material as the pipe. The seal may be formed of only that material without further additions.

Both intermediate edges may be convex.

The outermost edge may have a greater axial dimension than the innermost edge.

The innermost edge may have a greater axial dimension than the outermost edge.

The toroidal seal may be used to seal a pipe, and the toroidal seal may be formed from the same material as the pipe.

The toroidal seal may be formed from a resilient material, such that under compression between the end of a pipe to be sealed and a corresponding cap, the diameter of the toroidal seal may change from a rest diameter to a sealing diameter.

According to a second aspect of the present invention there is provided a method of manufacturing a toroidal seal for use in pipe gripping apparatus comprising cutting a piece of pipe to be gripped from a pipe to a suitable axial dimension to form a generally rectangular toroid having an outermost edge, an innermost edge and two intermediate edges, wherein the innermost edge and outermost edge are generally linear and parallel to one another, and machining at least one of the intermediate edges connecting the innermost edge and outermost edge to a generally convex shape.

By convex it should be taken that there is a general non-linearity about the shape of the intermediate edge, but may not conform to exact mathematical definition of “convex”. For example, the intermediate edge may be generally triangular with a filleted apex.

Both intermediate edges may be machined into a generally convex shape.

The outermost edge may have a greater axial dimension than the innermost edge.

According to a third aspect of the present invention there is provided a pipe and pipe gripping apparatus including at least one toroidal seal according to the first aspect of the present invention.

According to a fourth aspect of the present invention there is provided a method of sealing a pipe, comprising the steps of forming a toroidal seal from an end of the pipe or another pipe with a substantially identical diameter and cross-section, wherein the toroidal seal has a relatively short axial dimension in comparison to the pipe, and then compressing the toroidal seal between an end of the pipe to be sealed and either another length of pipe or an end cap.

The toroidal seal may cut at an angle to a central axis of the pipe therefore leaving an angled join between pipe and toroidal seal.

The toroidal seal may be cut from a pipe to a suitable axial dimension to form a generally rectangular toroid having an outermost edge, an innermost edge and two intermediate edges, wherein the innermost edge and outermost edge are generally linear and parallel to one another, and machining at least one of the intermediate edges connecting the innermost edge and outermost edge to a generally convex shape.

By convex it should be taken that there is a general non-linearity about the shape of the intermediate edge, but may not conform to exact mathematical definition of “convex”. For example, the intermediate edge may be generally triangular with a filleted apex.

Both intermediate edges may be machined into a generally convex shape.

The outermost edge may have a greater axial dimension than the innermost edge.

The innermost edge may have a greater axial dimension than the outermost edge.

### BRIEF DESCRIPTION OF THE DRAWINGS

Embodiments of the present invention will now be described, by way of example only, with reference to the following drawings, in which:

FIG. 1 is an end elevation of a first embodiment toriodal seal according to the present invention;

FIG. 2 is plan sectional elevation of the toriodal seal of FIG. 1 on section B-B;

FIG. 3 is a perspective view of the toriodal seal of FIG. 1 being placed onto a pipe PPPP for use with gripping apparatus to seal said pipe;

FIG. 4 is a perspective view of a gripping apparatus and end cap sealing the pipe of FIG. 3;

FIG. 5 is a sectional elevation of the toroidal seal of FIG. 1 within the gripping apparatus and end cap arrangement of FIG. 4;

FIG. 6 is a side sectional elevation of the toroidal seal of FIG. 1 shown between two pipes P; and

FIG. 7 is a side sectional elevation of a second embodiment toroidal seal according to the present invention shown between two pipes PP.

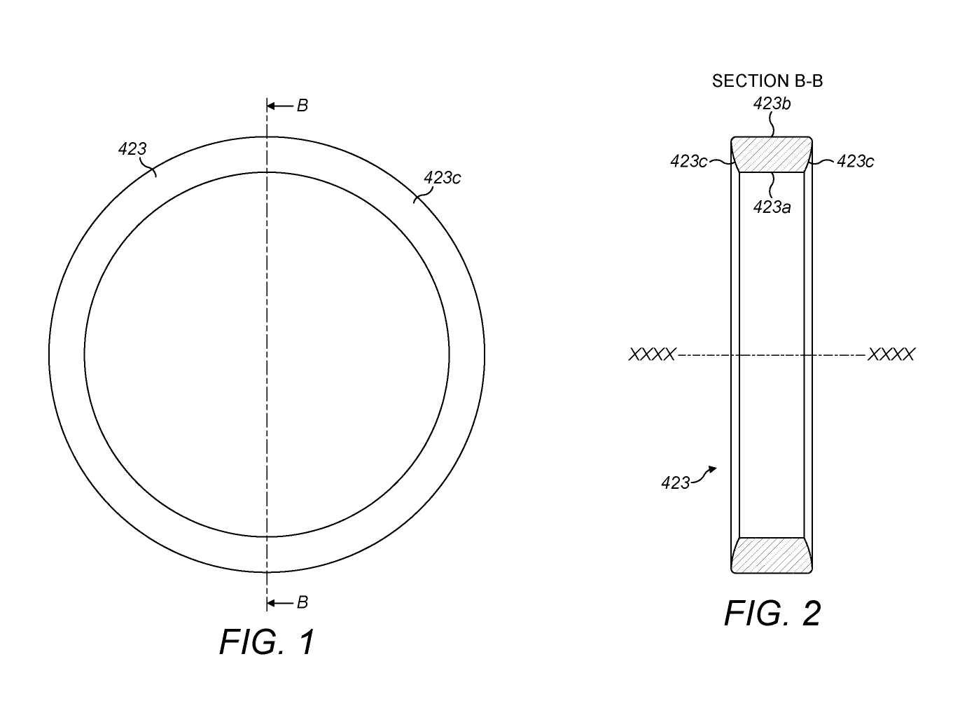

A toroidal seal 423 is depicted in FIG. 1. The toroidal seal 423 has a generally isosceles trapezoidal cross-section; however, as can be seen more clearly in FIG. 2, the cross-section itself is slightly more specific than this general description. The innermost edge 423a (from the perspective of the toroid formed) of the cross-section is substantially linear as is the outermost edge 423b. Both innermost edge 423a and outermost edge 423b are substantially parallel to the axis XXXX-XXXX. The innermost edge 423a has a lesser lateral dimension that the outermost edge 423b.

Intermediate edges 423c, which are arranged between outermost edge 423b and innermost edge 423a, are not linear but curve outwardly in a convex manner. They form an outward bulge around either face of the toroidal seal 423.

The toroidal seal 423 is formed from metal. It may ideally be formed from spare pipe material metal upon which it is used as will subsequently be described. It will be understood that it may be formed from other materials, such as different metals or any other deemed suitable by the skilled addressee.

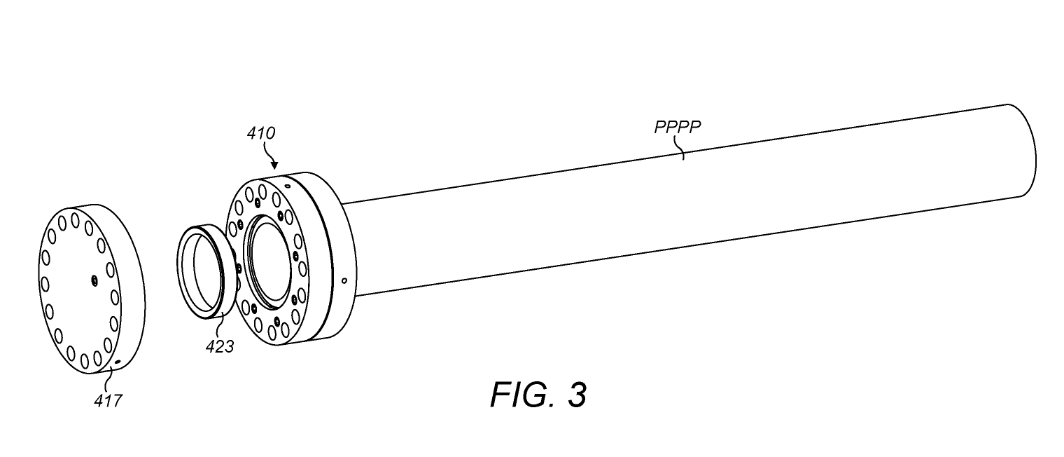

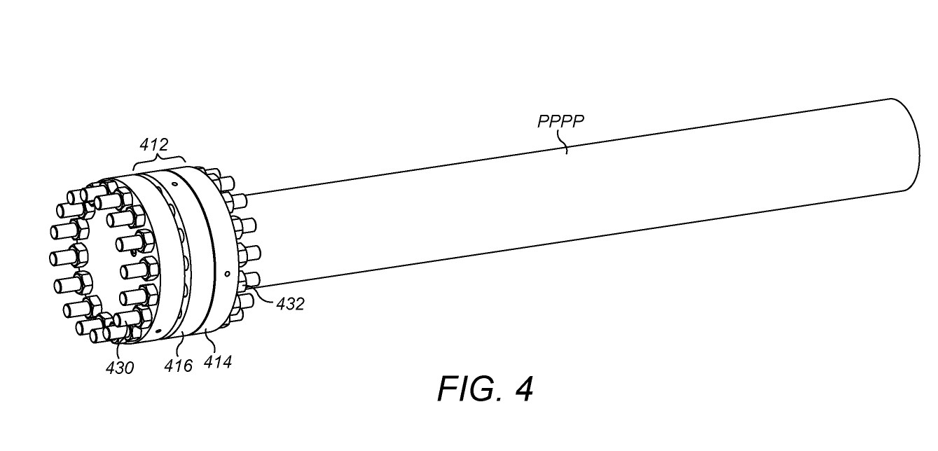

FIG. 3 depicts a pipe gripping apparatus 410 disposed around an end of a pipe PPPP to be sealed.

As can be seen from FIG. 3, the end of the pipe PPPP to which the apparatus 410 is attached is prepared to receive the toroidal seal 423 by being machined such that the leading edge has a complementary angled surface to meet the toroidal seal 423.

FIG. 3 details the placement of a toroidal seal 423 and end cap 417. The toroidal seal 423 is placed over the machined end of the pipe PPPP adjacent the second body section 416. The end cap 417 is placed over the toroidal seal 423 and the machined end of the pipe PPPP with the toroidal seal 423 being seated within toroidal seal recess 421.

Placement bolts 430 are again fed through placement bores 426,428,440 and corresponding nuts 432 are screwed onto the bolts 430, such that the first body section 414 and the end cap 417 are flanked by nuts 432. The nuts 432 are tightened drawing them together. This in turn urges the body sections 414, 416 and the end cap 417 together.

The toroidal seal 423 is compressed as the toroidal seal recess 421 is urged towards the pipe end PPPP. This compression causes a deformation of the toroidal seal recess 421. The machined end of the pipe will also tend to deform under this compression. The intermediate edges 423c tend to become less convex and more linear and correspondingly, the toriodal seal 423 expands slightly in diameter from its first or rest diameter to a second or sealing diameter. It will be appreciated that this expansion of en elastically deformable material such as a metal will result in a compressive force between the pipe end PPPP and the toroidal seal 423c.

There will be a point-like loading between the intermediate edges 423c, the machined pipe end and the seal recess 421. An axial seal is therefore created between the machined pipe end and the intermediate edge 423c. Elastic deformation of the materials that make up the various components should provide a positive bias for this sealing point.

Once the body section 412 and end cap 417 are adjacent one another, securing bolts 430 are placed through bores 426 and secured with nuts 432, which holds the end cap 417 to the body 412. In this arrangement, the pipe PPPP is sealed at its end.

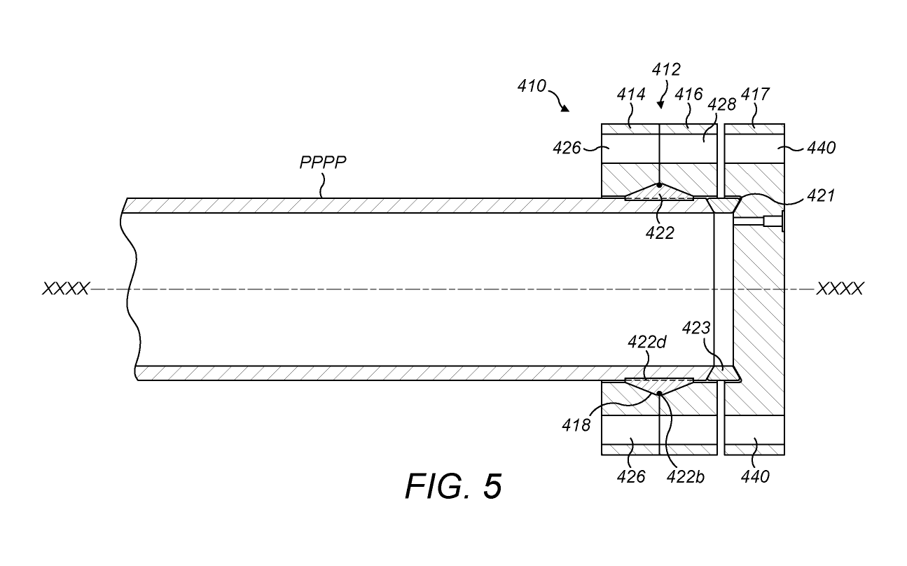

FIG. 5 shows the arrangement of the toroidal seal 423 between the body section 412 and end cap 417.

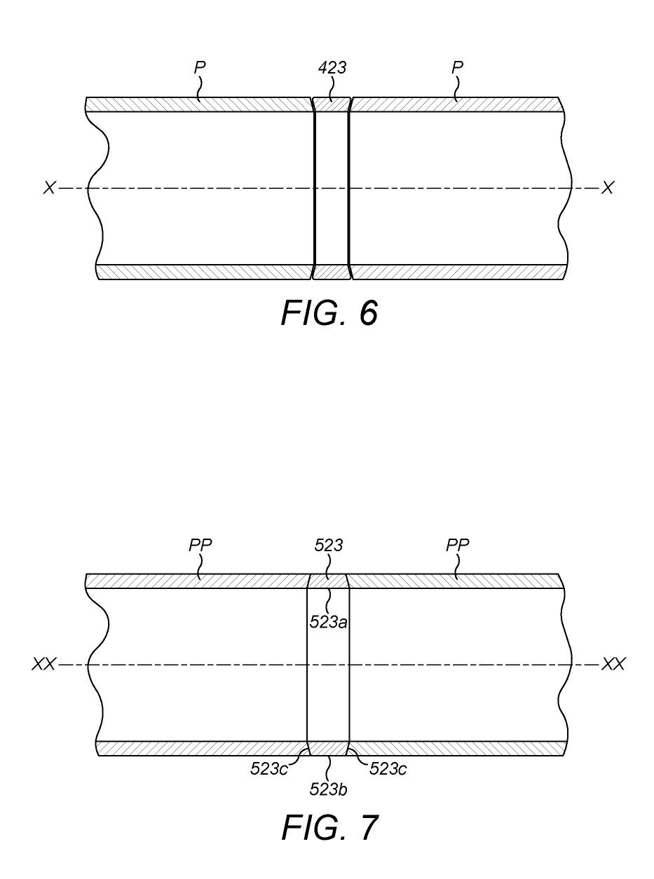

FIG. 6 shows the arrangement of the toroidal seal 423 between two pipes P centred on axis X-X.

The toroidal seal 423 of the present invention provides advantage especially in that it may be easily fabricated from a spare piece of pipe to be sealed. Moreover, in contrast to prior art solutions that provide radial sealing (i.e. sealing between layers of pipe and seal around a central axis), the toroidal seal 423 of the present invention only requires machining of the intermediate edges 423c. Machining may be limited to the intermediate edge 423c facing the end of the pipe.

A second embodiment toroidal seal 523 is shown in FIG. 7. As with the first embodiment, the toroidal seal 523 has a generally isosceles trapezoidal cross-section. The innermost edge 523a (from the perspective of the toroid formed) of the cross-section is substantially linear as is the outermost edge 523b. Both innermost edge 523a and outermost edge 523b are substantially parallel to the axis XX-XX. In contrast to the first embodiment, the innermost edge 523a has a greater lateral dimension that the outermost edge 523b.

Intermediate edges 523c, which are arranged between outermost edge 523b and innermost edge 523a, are not linear but curve outwardly in a convex manner. They form an outward bulge around either face of the toroidal seal 523.

The toroidal seal 523 is formed from metal. It may ideally be formed from spare pipe material metal upon which it is used as previously described in relation to the first embodiment. It will be understood that it may be formed from other materials, such as different metals or any other deemed suitable by the skilled addressee. It will also be understood that toroidal seal 523 may be used with the gripping apparatus previously described, albeit the seal recess 421 would need to be altered to accommodate the different seal shape.

In FIG. 6, toroidal seal 423 will be clamped between the two pipes P. It will be under an axially compressive load. It will tend to radially expand given the shape of the mating faces of the pipe ends P and the intermediate edges 423c. This arrangement may be more suitable to where an externmal pressure is being exerted on the arrangement, for example a subsea pipe where the external water pressure is greater than the internal pressure of pipe P, as the net inwardly directed pressure gradient will act against the radial expansion of the seal 423.

In FIG. 7, toroidal seal 523 will be clamped between the two pipes PP. It will be under an axially compressive load. It will tend to radially contract given the shape of the mating faces of the pipe ends P and the intermediate edges 523c. This arrangement may be more suitable to where an internal pressure is being exerted, for example a surface pipe where the pressure of the fluid being transported in the pipe PP is greater than the prevailing atmospheric pressure, as the net outwardly directed pressure gradient will act against the radial contraction of the seal 523.

Further modifications and improvements may be made without departing from the scope of the present invention. For example, the intermediate edges may not be strictly convex, and they may have a more general non-linearity about the shape of the intermediate edge, but may not conform to exact mathematical definition of “convex”. For example, the intermediate edge may be generally triangular with a filleted apex, or have a stepped arrangement.

The presently disclosed seals, and methods of sealing and manufacture of seals, provide an inexpensive and easily fabricated as hoc sealing method. Since the seals are made of the same material as that of the pipe that is being sealed, this will mitigate any galvanic corrosion.

Furthermore, the metal to metal seal provided should last much longer than prior art elastomeric sealing methods. Shaping the intermediate edges to generally convex edges provides a tendency to point load and thereby enhance the seal quality at this point load, which is useful given the generally difficult nature of obtaining an efficient metal to metal seal.

1. A seal comprising a seal body in the form of a toroid, having an outermost edge, an innermost edge and two intermediate edges, wherein the innermost edge and outermost edge are generally linear and parallel to one another, and wherein the two intermediate edges connect the innermost edge and outermost edge, at least one of said intermediate edges being generally convex.

2. The seal of claim 1 having a substantially similar cross-section to that of a pipe to be sealed.

3. The seal of claim 1 wherein the seal is formed from substantially the same material as a pipe to be sealed.

4. The seal of claim 3 wherein the seal is formed of only the material of the pipe to be sealed without further additions.

5. The seal of claim 1 wherein both intermediate edges are convex.

6. The seal of claim 1 wherein the outermost edge has a greater axial dimension than the innermost edge.

7. The seal of claim 1 wherein the innermost edge has a greater axial dimension than the outermost edge.

8. The seal of claim 1 wherein the seal is formed from a resilient material, such that under compression between the end of a pipe to be sealed and a corresponding cap, the diameter of the toroidal seal changes from a rest diameter to a sealing diameter.

9. A method of manufacturing a toroidal seal for use in pipe gripping apparatus comprising cutting a piece of pipe to be gripped from a pipe to a suitable axial dimension to form a generally rectangular toroid having an outermost edge, an innermost edge and two intermediate edges, wherein the innermost edge and outermost edge are generally linear and parallel to one another, and machining at least one of the intermediate edges connecting the innermost edge and outermost edge to a generally convex shape.

10. The method of claim 9 wherein both intermediate edges are machined into a generally convex shape.

11. The method of claim 9 wherein the outermost edge has a greater axial dimension than the innermost edge.

12. The method of claim 9 wherein the innermost edge has a greater axial dimension than the outermost edge.

13. (canceled)

14. A method of sealing a pipe, comprising the steps of forming a toroidal seal from an end of the pipe or another pipe with a substantially identical diameter and cross-section, wherein the toroidal seal has a relatively short axial dimension in comparison to the pipe, and then compressing the toroidal seal between an end of the pipe to be sealed and either another length of pipe or an end cap.

15. The method of claim 14 wherein the toroidal seal is cut at an angle to a central axis of the pipe therefore leaving an angled join between pipe and toroidal seal.

16. The method of claim 14 wherein the toroidal seal is cut from a pipe to a suitable axial dimension to form a generally rectangular toroid having an outermost edge, an innermost edge and two intermediate edges, wherein the innermost edge and outermost edge are generally linear and parallel to one another, and machining at least one of the intermediate edges connecting the innermost edge and outermost edge to a generally convex shape.

17. The method of claim 14 wherein both intermediate edges are machined into a generally convex shape.

18. The method of claim 14 wherein the outermost edge has a greater axial dimension than the innermost edge.

19. The method of claim 14 wherein the innermost edge has a greater axial dimension than the outermost edge.
